(19) United States
(12) Patent Application Publication
(10) Pub. No.: US 2014/0214614 A1
(43) Pub. Date: Jul. 31, 2014

(54) CONSULTATIVE ONLINE SALE OF BUSINESS APPLICATIONS

(71) Applicants: Nadim Razvi, Speyer (DE); Marco Sachs, St. Leon-Rot (DE); Ulrike Muench, Bruchsal (DE)

(72) Inventors: Nadim Razvi, Speyer (DE); Marco Sachs, St. Leon-Rot (DE); Ulrike Muench, Bruchsal (DE)

(73) Assignee: SAP AG, Walldorf (DE)

(21) Appl. No.: 13/754,387

(22) Filed: Jan. 30, 2013

(51) Int. Cl. G06Q 30/06

(52) U.S. Cl. CPC G06Q 30/0617
USPC 705/26.43

(57) ABSTRACT

A system for transacting business applications among a prospective buyer, a provider, and a third-party partner includes a server including one or more processors and memory storing one or more programs, the one or more programs including instructions to: provide for display of an interface of an online store of business applications, the online stored being accessible by the prospective buyer, the provider, and the third-party partner; in response to receiving a request for a business application from the prospective buyer, retrieve a profile of the prospective buyer; identify information of users who have similar profiles to the profile of the prospective buyer based on purchase history; analyze the purchase history of the identified users; determine a configuration of the business application based on the analysis; and provide the configuration of the business application to the prospective buyer as a recommendation.

### FIELD OF THE DISCLOSURE

The present disclosure is directed to systems and methods for transacting business applications, in particular, directed to an online system and method for facilitating the sales of business applications among a provider, a partner of the provider, and a prospective buyer.

### BACKGROUND

Consumers may directly buy software applications off the shelves or online, and install these consumers software applications on a computer with little or no further customization. In contrast to the transaction of consumer software applications, prospective buyers of business software applications are commonly sophisticated users who often require extensive customization to meet the specific requirements of their business. Thus, currently, business software applications are transacted predominantly through face-to-face meetings and negotiations between the prospective buyer of the business software applications and the business solution provider. To facilitate the transaction, the business solution provider often employs one or more third-party partners to help the transaction. The third-party partners may be certified by the solution provider as value-added service providers who may be a local representative of the solution provider and authorized to customize a business software application on behalf of the solution provider by adding (or subtracting) certain functionalities. The third-party partners may also be authorized to sell the business software application at prices authorized by the solution provider. Thus, the transactions of business software applications may require multiple meetings that include multiple parties in a face to face setup.

### BRIEF DESCRIPTION OF THE DRAWINGS OF THE EXAMPLE EMBODIMENTS

FIG. 1 a system of an online store for business applications according to an embodiment of the present disclosure.

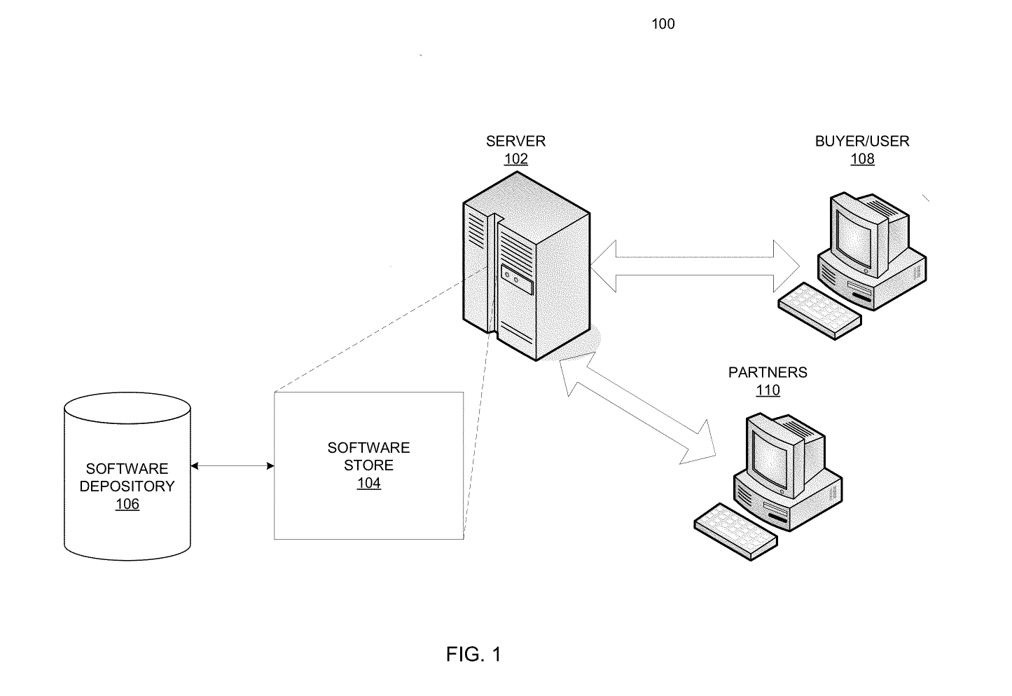

FIG. 2 illustrates components of the online store according to an embodiment of the present disclosure.

FIG. 3 illustrates different complexity levels of the online store according to an embodiment of the present disclosure.

FIG. 4 a process of the transaction using the online store according to an embodiment of the present disclosure.

FIG. 5 is a system view of the online store according to an embodiment of the present disclosure.

### DETAILED DESCRIPTION OF THE EXAMPLE EMBODIMENTS

The face to face meetings for the transaction of business software applications require the participants to travel to a destination which can be costly and time consuming. Therefore, there is a need to improve the process of business software application transactions.

Embodiments of the present disclosure may include a system for transacting business applications among a prospective buyer, a provider, and a third-party partner includes a server that includes memory storing one or more programs and a processor that is configured to execute the one or more programs to: provide for display of an interface of an online store of business applications, the online stored being accessible by the prospective buyer, the provider (such as a business solution provider), and the third-party partner; in response to receiving a request for a business application from the prospective buyer, retrieve a profile of the buyer; identify information of users who have similar profiles to the profile of the prospective buyer based on purchase history; analyze the purchase history of the identified users; determine a configuration of the business application to the prospective buyer; and provide the configuration of the business application to the prospective buyer as a recommendation.

Embodiments of the present disclosure may include a method that includes providing for display of an interface of an online store of business applications, the online store being accessible by a provider and a prospective buyer; in response to receiving a request for a business application from the prospective buyer, retrieving a profile of the buyer; identifying information of users who have similar profiles to the prospective buyer based on purchase history; analyzing the purchase history of the identified users; determining, by the processor, a configuration of the business application; and providing the configuration of the business application to the prospective buyer as a recommendation.

Embodiments of the present disclosure include systems and methods that provide an online sale portal for facilitate the consultative sale of business software applications from business solution providers to business solution buyers with the help of third-party partners of the solution providers. Compared to the current art, embodiments of the present disclosure may have the advantages of significantly reduced cost for the sales of business software applications and significantly enhanced flexibility for the business solution providers, the business software application buyers, and the third-party partners to meet at any time. Furthermore, embodiments of the sale portal include enhanced features that may further facilitate the negotiation and transaction among the parties.

In one embodiment, the sale portal may support transaction of business software applications which may include configuration and implementation of the business software. In one embodiment, a system of the present disclosure may support a self-service scenario where a prospective buyer may go through the transaction process on its own without the help of the third-party partner. In an alternative embodiment, a system of the present disclosure may support a consultative sales approach in which the prospective buyer may be guided through the customization process by the solution provider and/or the third-party partner.

Embodiments of the present disclosure may include a computer system 100 that may include a server computer 102 of the solution provider. The server computer may be connected to a buyer's computer 108 and/or a third-party partner's computer 110 through a network 108. The server computer may include a hardware processor (not shown) that may be configured with a software store 104 which may be a portal accessible by the buyer and third-party partner through their respective computers 108, 110. Embodiments of the present disclosure may also include a database having stored thereon a software depository 106. The software depository 106 may include business software applications that may be purchased by the buyer.

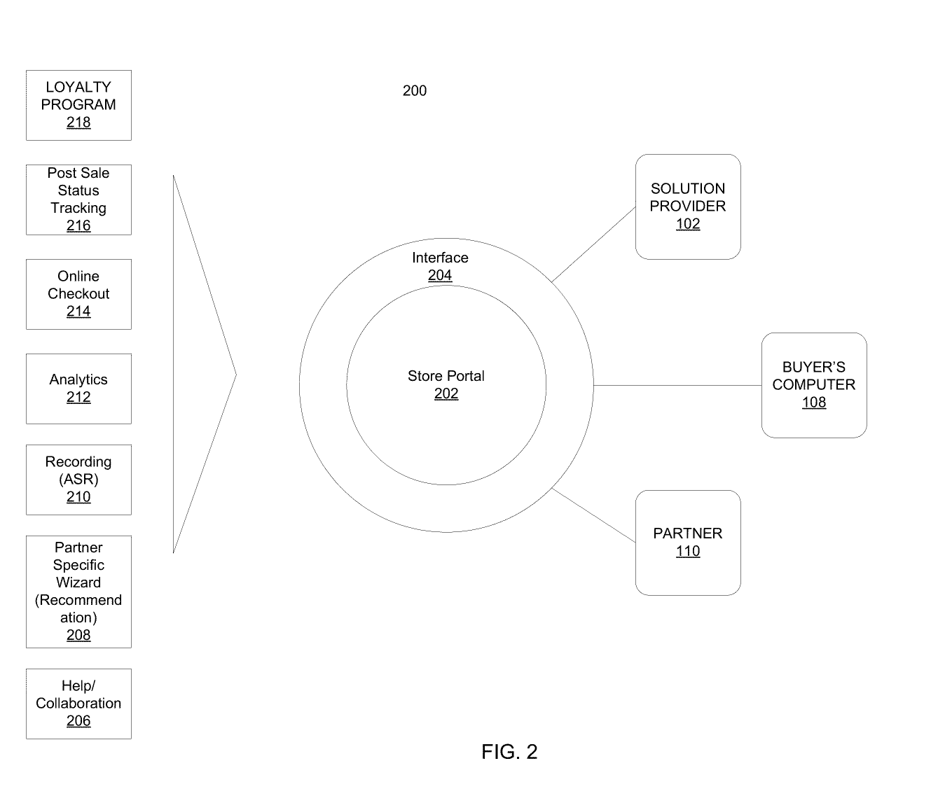

In operation, the buyer may access software store 104, or the online business software application sales portal, through network 108 to work collaboratively with the business solution provider and/or the third-party partner to purchase a customized business software application. FIG. 2 illustrates a diagram that depicts the software store according to an embodiment of the present disclosure. As shown in FIG. 2, the online software store 200 may include a store portal 202 and an interface 204. The interface 204 may include a graphic user interface (GUI) on which the buyer, the solution provider, and the third-party partner may access the store portal 202. In one embodiment, a processor may be configured to execute store portal application 202 that may support features for facilitate the communication among these three parties. In one embodiment, the store portal may support a collaboration module 206, a partner specific communication wizard 208, a conversation recording and automatic speech recognition module 210, and an analytics module 212. Additionally, the store portal may also support an online checkout process 214, a post-sale status tracking module 216, and a loyalty module 218.

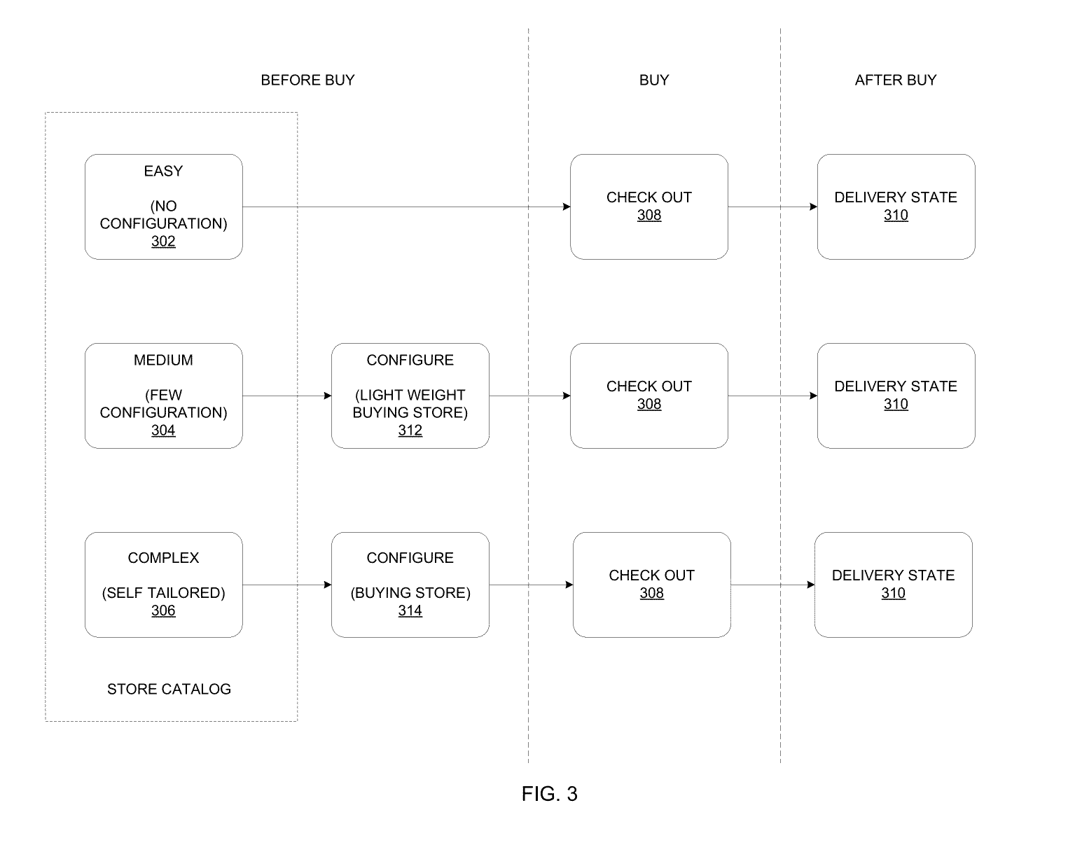

In one embodiment, the online software store may provide different levels of functionalities with respect to different software applications. FIG. 3 illustrates a software store 300 that includes three levels of functionalities according to an embodiment of the present disclosure. As shown in FIG. 3, the three levels may be an easy level 302, a medium level 304, and a complex level 306. The easy level 302 may be directed to software applications that do not need configurations or a first type of software applications that may be easily installed by the buyer. Buyers may buy this first type of software applications directly from the online store without helps either from the solution provider or from the third-party partner. The online store 300 may further include an online checkout component 308 through which the buyer may make the purchase transaction of the software application. The checkout component may display the selected software application and blanks for the buyer to select and enter payment information such as credit card information. The checkout component 308 may further include a delivery selection and a confirmation selection. For example, the buyer may select to run the installation directly from the online portal, or to download the installation package to a local machine of the buyer, or to receive a software application package such as a DVD in mail. The online store 300 may further include a delivery status component 310 through which a buyer may check whether the purchased software application has been delivered.

The medium level 304 may be directed to software applications that may need minor configurations. For example, the buyer may want to buy a software application whose functionalities are already in existence and need only a few customizations. For the medium level of software applications, the online store may provide a configuration functionality 312 that may help to achieve these minor configurations. The configuration functionality 312 may include tools for the buyer to work with solution provider and/or a third-party partner. Since the configuration is minor, the medium level may not include all of the tools available for the complex level. For example, in one embodiment, the configuration component 312 for the medium level 304 may include the help and collaboration component 206 through which, the buyer, the solution provider, and the third-party partner may work together to configure a software application based on the buyer's needs and software features that the solution provider may provide. The help and collaboration component 206 as discussed below may include capabilities for the parties to communicate with each other, share documents, conduct conferences and perform online trial and demonstration. Similar to the easy level, after the configuration, the buyer may proceed to complete the purchase transaction at checkout component 308 of the software store 300. After the purchase, the buyer may check the status of the purchase through the delivery status component 310.

The complex level 306 may be directed to software applications that may need heavy configuration with the help from the solution provider and the third-party partner. For example, in addition to the available features, the buyer may specify certain functionalities that may not be available and require customized codes by the solution provider and/or the partner. For such scenario, the software store 300 may provide a complete line of tools for the buyer, the solution provider, and the third-party partner to collaborate. In one embodiment, the software store may include a configuration component 314 that may include a help and collaboration component 206, a partner specific wizard 208, a speech recording and analysis component 210, and an analytics component 212. The help and collaboration component 206 may include capabilities for the parties to communicate with each other, share documents, conduct conferences and perform online trial and demonstration. The partner specific wizard 208 may include a partner's knowledge of a specific industry based on which the partner may apply individual settings to the software application. The speech recording and analysis component 210 may record the conversations among the buyer, the solution provider, and the third-party partner, and may further analyze the recorded speech. Based on the analysis of the speech content, the speech recording and analysis component 210 may intelligently determine what software features the buyer may need and recommend these features to the parties. The analytics component 212 may include a knowledge database that may store the different configurations of all customers. Each customer may correspondingly have a profile indicating the nature of the customer's business. Thus, the knowledge base may include links between certain configurations and certain classifications of profiles. Thus, the analytics component may recommend configurations to a prospective buyer based on the buyer's profile. Similar to the easy and medium levels, after the configuration, the buyer may proceed to complete the purchase transaction at checkout component 308 of the software store 300. After the purchase, the buyer may check the status of the purchase through the delivery status component 310.

In one embodiment, a prospective buyer may register itself at the software store by creating a profile which may contain the buyer's identity, industry, and needs. The registered buyer may be able to access features of the online software store. In one embodiment, the prospective registered buyer may log onto the online store. Based on the history record and the profile of the buyer, the online store may display to the buyer a first interface page which may include selections of available software applications at the online software store. In response to a selection of a particular software application, the online software store may determine which level of support of the selected software application needs. If the selected software application does not require customization or helps from the service provider or from the third-party partner, the online software store may proceed with displaying the easy level 302 of the online software store. If the selected software application needs only minor configuration, the online software store may proceed with displaying the medium level 304. Finally, if the selected software application needs only substantial configuration, the online software store may proceed with displaying the complex level 304.

The help and collaboration component 206 may be configured with communication channels that allow the buyer, the solution provider, and the third-party to collaborate. In one embodiment, the soft store 300 may provide social network tools, a video conference tool, a document upload zone, and a meeting request tool. The social network tools may include at least one of an RSS feed, a Facebook® icon (such as “like”), a Twitter® icon (such as “follow”), and a Google+ icon (such as “share”). Therefore, the prospective buyer may automatically receive summaries of information distributed by the solution provider and the third-party via the RSS feed. The prospective buyer may also receive information from the solution provider and/or the third-party partner through its Facebook®, Twitter®, or Google+ accounts. Conversely, the prospective buyer may also transmit information such as a preference to the solution provider and/or the third-party partner. For example, the prospective buyer may vote on multiple choices created by the solution provider and/or the third-party partner. The social network tools may also allow the registered buyer to consult parties other than the solution provider or the partner. For example, the social network tools may allow the registered user to chat with other buyers either registered or unregistered.

For instantaneous interactions, the online software store may be configured with a video conference tool that may allow the prospective buyer to have a “face to face” meeting with the solution provider and/or the third-party partner. Any one of the prospective buyer, the solution provider and/or the third-party partner may initiate the video conference. Through the “face to face” meeting, the parties may discuss the needs of the buyer and specify the configuration of the software application. Additionally, the online software store may provide a common workspace in which parties may upload documents to share.

In one embodiment, the online software store may be configured with a partner specific wizard 208 that may help the configuration of software applications. The partner specific wizard 208 may be a program that is executed on a processor that may read the profile of the registered buyer and apply rules established by a third-party partner to the preferences of the buyer to generate a preliminary configuration of the software application. The parties may work together to refine the preliminary configuration of the software application to generate the final configuration.

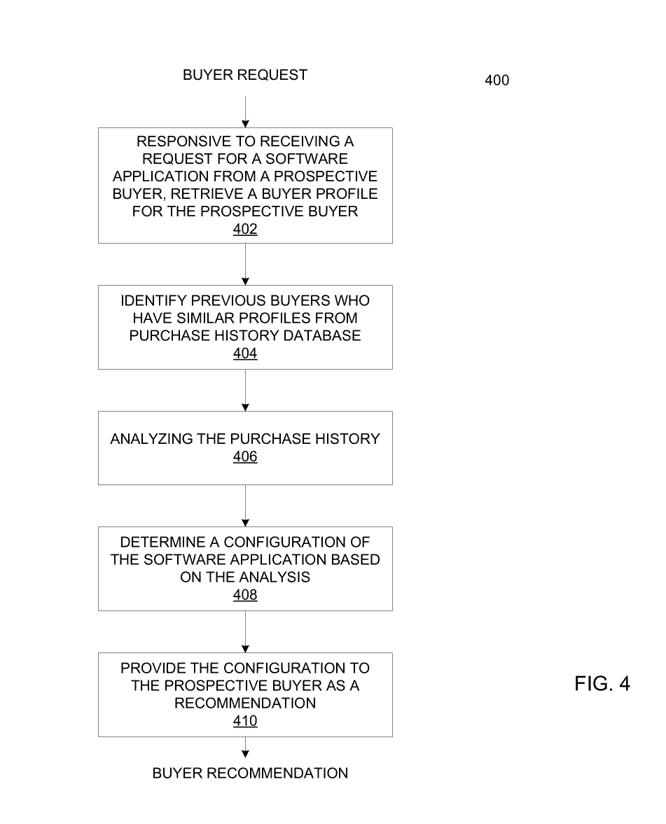

FIG. 4 illustrates a process 400 of the partner specific wizard according to an embodiment of the present disclosure. At 402, the processor may execute the partner specific wizard to receive a buyer's request for a software application. In response to receiving the request, the partner specific wizard may retrieve a previously-created profile of the buyer. At 404, the wizard may identify users (or previous buyers) who have similarly profiles to the prospective buyer stored in a purchase history database. At 406, the wizard may further analyze the previous purchase history. Based on an analysis of the profile of the present buyer and historical data of previous buyers, at 408, the wizard may determine a preliminary configuration of the software application to the prospective buyer. At 410, the configuration may be provided to the prospective buyer as a recommended configuration that may meet the requirements of the prospective buyer.

In one embodiment, the online software store may be configured with a speech recording and analysis component 210 which may include a device for recording the conversation among the prospective buyers and convert the recorded speech into text (or automatic speech recognition). For example, a mobile device (such as an IPhone 4S) configured with an automatic speech recognizer (such as Siri) may serve as the speech recording and analysis component 210. The speech recognizer may transcribe speech signals captured by a microphone into texts format. The processor may be further configured with an analyzer that may analyze the text to identify textual elements relating to offerings and configurations of the software application. For example, the analyzer may associate portions of the textual transcription with a speaker. The analyzer may also identify monetary amounts associated with offerings of features relating to the software application and determine a final negotiated price based on context-specific semantics. The information extracted from the transcript of the recorded conversation among the buyer, the solution provider, and the third-party partner may be advantageously used to create a preliminary version of the sales contract. One advantage of using the speech recording and analysis component 210 to help create the sales contract is that the contract may be created timely with less cost.

In one embodiment, the online software store may be configured with an analytics component that may make a recommendation to a prospective buyer based on an analysis of all customers' data available to the store. With increasing number of configurations executed through the online software store, the store may accumulate a large amount of knowledge about what features a prospective buyer may need. The store may have a knowledge database of all past buyers who have executed purchase order from the online software store. Additionally, each third-party partner or solution provider may also have partner specific knowledge about buyers that had executed through partners. The different configurations of the customers may indicate what is actually needed in the market. In particular, certain sets of configurations may be linked to buyer's profile based on factors such as industry, region, company sizes, and legal form of the company. The usage of the accumulated knowledge may be beneficial for optimizing the profile and making dedicated recommendations to the prospective buyer.

In one embodiment, in response to request seeking configurations by a prospective buyer, the online software store may execute a crawler program that may collect information from the solution provider's knowledge databases and from each partner's knowledge database. Further, the online software store may retrieve the buyer's profile. The analytics component of the online software store may compare the profile with profiles of past buyers to identify those buyers who have similar backgrounds. Similarities may include same industry, same region (such as countries), similar sizes or same legal forms. Based on the similarity analysis, the online software store may create a configuration for the prospective buyer. The created configuration may embody the features of configurations of past buyers who are similar to the prospective buyer. Finally, the online software store may recommend the created configuration to the prospective buyer.

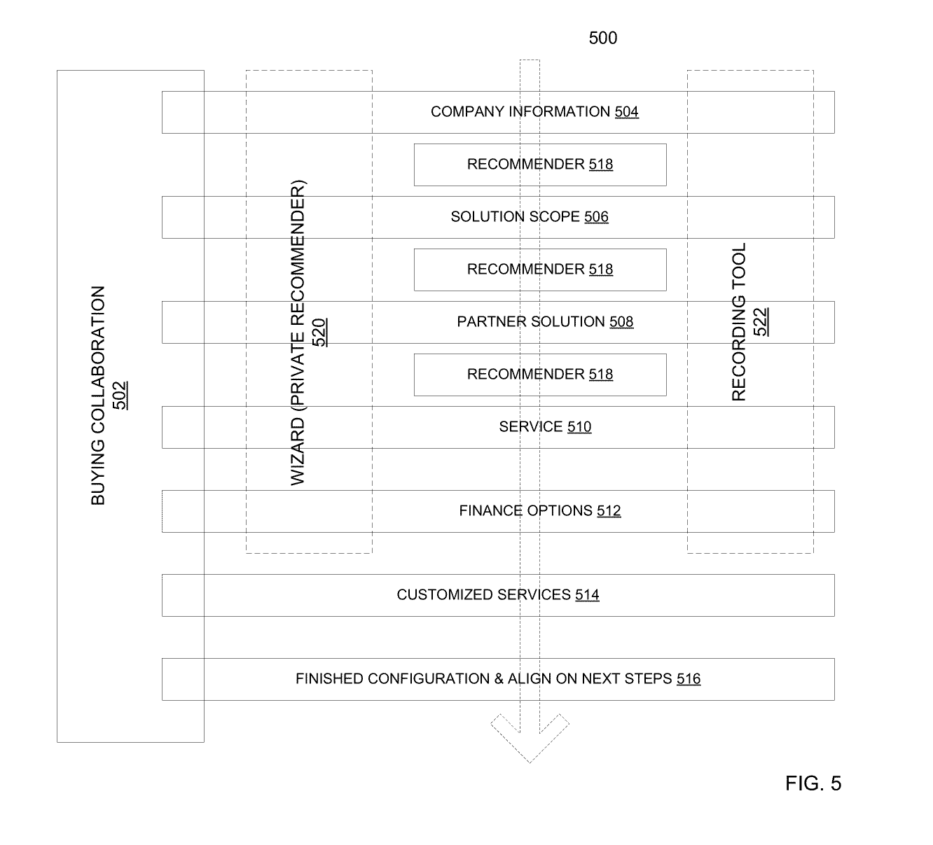

FIG. 5 illustrates components available at the complex level of the online software store according an embodiment of the present disclosure. The online software store 500 may include buying collaboration component 502 which may be available for registered buyers. The buying collaboration component 502 may have a wizard component acting as a private recommender 520 for the buyer. The wizard 520 may have access to the buyer company information 504, and based on the company information 504, make recommendations of solutions 506 or partner solution 508 to the prospective buyer through recommender 518. The recommender 518 may be a communication means such as e-mail, video conference, or social media channels. The wizard 520 may also provide standard service 510 and finance option 512 to the prospective buyer. Additionally, the buying collaboration component 502 may be coupled to a recording tool 522 that records the communications among the prospective buyer, the solution provider and/or the third-party partner. The recording may be analyzed to assist the recommender 518 to make recommendations to the prospective buyer. Based on the recommendation, the solution provider and/or the third-party partner may provide customized services 514 to the prospective buyer in accordance to the buyer's needs. After the customized services, the configuration of business application for the buyer may be completed and aligned with the buyer's computer systems at 516.

Although the present disclosure has been described with reference to particular examples and embodiments, it is understood that the present disclosure is not limited to those examples and embodiments. Further, those embodiments may be used in various combinations with and without each other. The present disclosure as claimed therefore includes variations from the specific examples and embodiments described herein, as will be apparent to one of skill in the art.

What is claimed is:

1. A computer-implemented method, comprising:
providing for displaying, by a processor, an interface of an online store of business applications, the online store being accessible by a provider and a prospective buyer;
in response to receiving a request for a business application from the prospective buyer, retrieving, by a processor, a profile of the prospective buyer;
identifying, by the processor, information of users who have similar profiles to the profile of the prospective buyer based on purchase history;
analyzing, by the processor, the purchase history of the identified users;
determining, by the processor, a configuration of the business application based on the analysis; and
providing, by the processor, the configuration of the business application to the prospective buyer as a recommendation.

2. The method of claim 1, wherein the online store is accessible by a third-party partner of the provider, wherein the provider is one of a solution provider and a service provider.

3. The method of claim 2, wherein the prospective buyer, the provider, and the third-party partner access the online store through the interface of the online store.

4. The method of claim 3, wherein the online store includes different levels of functionalities, and wherein the interface displays a particular level of functionality in accordance to a complexity of the business application requested by the prospective buyer.

5. The method of claim 4, wherein the interface of the online store displays an easy level for business applications that do not need configurations by the provider or by the third-party partner.

6. The method of claim 5, wherein the easy level includes a collaboration component that is configured with communications channels that allows the prospective buyer, the provider, and the third-party partner to collaboratively configure the business application online.

7. The method of claim 4, wherein the interface of the online store displays an intermediate level for business applications that need light configurations.

8. The method of claim 7, wherein the intermediate level includes a collaboration component that is configured with communications channels that allows the prospective buyer, the provider, and the third-party partner to collaboratively configure the business application online.

9. The method of claim 4, wherein the interface of the online store displays a complex level for business applications that need heavy configuration.

10. The method of claim 9, wherein the complex level includes at least one of a collaboration component, a partner specific wizard, a speech recording and analysis component, and an analytic component.

11. The method of claim 10, wherein
the collaboration component is configured with communications channels that allow the prospective buyer, the provider, and the third-party partner to collaboratively configure the business application online,
the partner specific wizard includes a database having stored thereon the third-party partner's knowledge of a specific industry based on which the third-party partner applies individual settings to the business application,
the speech recording and analysis component records conversation among the prospective buyer, the provider, and the third-party partner, based on analysis of the recorded speed content, determines which features the prospective buyer needs, and recommends the features to the prospective buyer, and
the analytic component includes configurations of the previous users.

12. A system for transacting business applications among a prospective buyer, a provider, and a third-party partner, comprising:
a server including one or more processors and memory storing one or more programs, the one or more programs including instructions to:
provide for display an interface of an online store of business applications, the online stored being accessible by the prospective buyer, the provider, and the third-party partner;
in response to receiving a request for a business application from the prospective buyer, retrieve a profile of the prospective buyer;
identify information of users who have similar profiles to the profile of the prospective buyer based on purchase history;
analyze the purchase history of the identified users;
determine a configuration of the business application based on the analysis; and
provide the configuration of the business application to the prospective buyer as a recommendation.

13. The system of claim 12, wherein the online store has different levels of functionalities, and wherein the interface displays a particular level of functionality in accordance to a complexity of the business application requested by the prospective buyer.

14. The system of claim 13, wherein the interface of the online store displays an easy level for business applications that do not need configurations by the provider or by the third-party partner, wherein the easy level includes a collaboration component that is configured with communications channels that allow the prospective buyer, the provider, and the third-party partner to collaboratively configure the business application online.

15. The method of claim 13, wherein the interface of the online store displays an intermediate level for business applications that need light configurations.

16. The system of claim 15, wherein the intermediate level includes at least one of a collaboration component that is configured with communications channels that allow the prospective buyer, the provider, and the third-party partner to collaboratively configure the business application online.

17. The system of claim 13, wherein the interface of the online store displays a complex level for business application that need heavy configuration.

18. The system of claim 17, wherein the complex level includes at least one of a collaboration component, a partner specific wizard, a speech recording and analysis component, and an analytic component.

19. The system of claim 18, wherein
the collaboration component is configured with communications channels that allow the prospective buyer, the provider, and the third-party partner to collaboratively configure the business application online,
the partner specific wizard includes a database having stored thereon the third-party partner's knowledge of a specific industry based on which the third-party partner applies individual settings to the business application,
the speech recording and analysis component records conversation among the prospective buyer, the provider, and the third-party partner, based on analysis of the recorded speed content, determines which features the prospective buyer needs, and recommends the features to the prospective buyer, and
the analytic component includes configurations of the previous users.

20. A machine-readable non-transitory storage medium having store thereon executable instructions that when executed, perform a method, the method comprising:
providing for display of an interface of an online store of business applications, the online stored being accessible by a provider and a prospective buyer;
in response to receiving a request for a business application from the prospective buyer, retrieving a profile of the prospective buyer;
identifying information of users who have similar profiles based on a purchase history;
analyzing the purchase history of the identified users;
determining a configuration of the business application based on the analysis; and
providing the configuration of the business application to the prospective buyer,
wherein the online store has different levels of functionalities, and wherein the interface displays a particular level of functionality in accordance to a complexity of the business application requested by the prospective buyer.
